(19) United States
(12) Patent Application Publication
(10) Pub. No.: US 2014/0170756 A1
(43) Pub. Date: Jun. 19, 2014

(54) PROCEDURE FOR DISPENSING SAMPLE CUVETTES AND REAGENTS, AND APPARATUS FOR THIS PURPOSE

(71) Applicant: DIAGON Kft., Budapest (HU)

(72) Inventors: Matyas Petoe, Budapest (HU); Laszlo Izsak, Budapest (HU); Jozsef Antal, Budapest (HU)

(73) Assignee: DIAGON Kft., Budapest (HU)

(21) Appl. No.: 14/187,182

(22) Filed: Feb. 21, 2014

Related U.S. Application Data
(63) Continuation-in-part of application No. PCT/HU2012/000017, filed on Mar. 21, 2012.
(60) Provisional application No. 61/793,232, filed on Mar. 15, 2013.

(30) Foreign Application Priority Data
Aug. 22, 2011 (HU) P1100457

(51) Int. Cl. G01N 35/02

(52) U.S. Cl. CPC G01N 35/025
USPC 436/45; 422/64

(57) ABSTRACT

Apparatus and processes for placing sample cuvettes at measuring points, dispensing a reagent into the cuvettes, and forwarding used cuvettes to a receptacle after finishing the measurements. The apparatus has an incubation module (1) for incubating sample cuvettes (7), a reagent module (3) containing a reagent of an amount needed for the assay, and a measuring module (2) favorably accommodating optical measuring points. Arms (K1 . . . KN) can move the sample cuvettes (7).

This application claims benefit as a non-provisional of copending U.S. provisional appl. No. 61/793,232 filed on Mar. 15, 2013, and the present application claims benefit as a C-I-P continuation-in-part of copending PCT International application no. PCT/HU2012/000017 filed on Mar. 21, 2012 designating the U.S., claiming benefit of priority to prior Hungarian national application no. HU-P1100457 filed on Aug. 22, 2011, this priority claim being identically applicable to the present application, and U.S. provisional appl. Ser. No. 61/793,232 as well as parent PCT appl. no. PCT/HU2012/000017 are entirely incorporated herein by reference in their entireties and as to all their parts, for all intents and purposes, as if identically set forth in full herein.

The present disclosure relates to a procedure for dispensing sample cuvettes and reagents, and apparatus for this purpose. In an automatic measuring device, with the compact and quick solutions according to the present disclosure the sample cuvettes may be moved and the reagent may be drawn simultaneously. As a result, the measurement may be quickly prepared and started at the desired measuring location of the device.

The large number of measurements performed in different areas of diagnostics necessarily called for the automation of certain test series. Such automation may be observed, for example, in in vitro blood coagulation diagnostics, which the present disclosure primarily deals with, noting in addition that the present solution may be extended to any other automatic diagnostic apparatus.

In automatic apparatuses the sample cuvettes, the reagent holders and the measuring locations are arranged with respect to each other to enable movement mostly along x-y coordinates, favorably right-angled coordinates, or they have a circular arrangement suiting rotating coordinates, favorably cylindrical coordinates.

In the case of arrangements along x-y coordinates, favorably right-angled coordinates, as included in U.S. Pat. Nos. 5,646,046 and 7,955,555 relatively large distances need to be spanned, and several dispensing units having a stable drive mechanism need to be moved to realize all steps of the optical measurement preparation phases. A separate dispensing unit is used to move the sample cuvette to the measuring point, and a separate dispensing unit is used to dispense the reagent into the cuvettes containing samples. In most cases these robust solutions arranged in this way are not sufficiently fast.

In patent specifications no. EP 1840555A1 and EP 2278336A2, or U.S. Pat. No. 4,325,909 and U.S. Pat. No. 5,439,646, the steps of the optical measurement preparation phases (such as placing the sample in the cuvette, moving the cuvette containing the sample to the measuring point, or dispensing the reagent into the cuvettes containing samples) are realized by using cuvettes placed on one or two large circular discs and by allocating dispensing units, arms with different axes of rotation to the individual dispensing steps. On these different axes of rotation, with light arm structures suiting rotating coordinates, favorably cylindrical coordinates, the movements may be realized quickly. The number of arms suits the number of the tasks to be performed, and the arms may be positioned in many different ways. On the basis of the above, this arrangement has a significant space demand, and often it allows excessively complicated forms of realization.

There are complex-solution automatic apparatuses, in which the individual tasks are performed along x-y coordinates, favorably right-angled coordinates, and rotating coordinates, favorably cylindrical coordinates. Such a solution is described for example in U.S. Pat. No. 5,587,129, where the movement of the cuvette in the direction of the measuring point is realized with the help of arms suiting x-y coordinates, favorably right-angled coordinates, while the dispensing of the reagent is realized separately, with the help of arms suiting rotating coordinates, favorably cylindrical coordinates. This arrangement also has a significant space demand and an excessively complicated construction, so it is less favorable from the aspects of measurement technology and maintenance.

It is desirable to eliminate the disadvantages of the above solutions and to create apparatus, which is compact, fast, technically simple and economical, where with automatic apparatuses the movement of the sample cuvettes and the dispensing movements between the reagent holder and the measuring point are realized in a quick and simple manner.

By achieving a measuring point arrangement of suitable rotating coordinates, favorably cylindrical coordinates, then the movement and dispensing with arms along rotating coordinates, favorably cylindrical coordinates, arranged in accordance with the present disclosure is faster and simpler than in the case of the known solutions. Furthermore, modular construction may be especially favorable, as in this way the individual modules—the incubation module storing the sample cuvettes, the reagent holder module, the measuring module—may be adjusted and synchronized especially favorably. It may be further advantageous if the incubation module, the removal point of the sample cuvettes, the reagent removal point of the reagent holder module and the measuring points of the measuring module are arranged along a circular arc, and the center of motion or axis of the arms moved along rotating coordinates, favorably cylindrical coordinates, is set up in the geometric center of the circular arc, then a favorably compact and fast solution can be reached. Therefore, each arm moved along rotating coordinates, favorably cylindrical coordinates, should be favorably placed on this common axis. In this regard, each arm needs to reach one measuring point at a time. By creating a favorable control program it is achievable that the individual steps do not hold up each other, the arms do not delay each other in performing the tasks.

The present disclosure relates to processes for placing sample cuvettes at measuring points and dispensing a reagent in the cuvettes, in the course of which from the incubation place cuvettes containing samples are moved from the incubation place to measuring points, and a reagent of the necessary amount from the reagent holders is dispensed in the cuvettes. The procedure is based on that the cuvette removal point of the incubation module, the reagent removal point of the reagent holder module, and the measuring points of the measuring module are arranged along a circular arc. The placement of the sample cuvettes at the measuring points, the dispensing of the reagent in the cuvettes placed in the measuring module, and, after finishing the measurements, the forwarding of the used cuvettes to the receptacle are realized with arms moved from the common geometric center of the circular arc created according to the above as from a common center of rotation, with a common axis of rotation.

In favorable procedural solutions, the placement of the sample cuvettes at the measuring points, the dispensing of a reagent into the cuvettes, and, after completion of the measurements, the forwarding of the used cuvettes to receptacle, is ensured with arms moved separately.

The procedure may also be realized in such manner that the placement of the sample cuvettes at the measuring points, the dispensing of a reagent into the cuvettes and after completion of the measurements, the forwarding of the used cuvettes to the receptacle, are ensured with arms moved jointly.

In further favorable realization of the procedure, the placement of several sample cuvettes at the measuring points, the dispensing of a reagent into several cuvettes, and after completion of the measurements the forwarding of the used cuvettes to the receptacle are realized simultaneously.

Advantageously, the arms are moved horizontally and vertically, and a given arm (or arms) is (are) moved only in one direction at a time.

It may be a favorable form of realization of the procedure, in the case of several arms, to perform horizontal and vertical movement continuously, in parallel.

The present disclosure also relates to apparatus for placing sample cuvettes at measuring points, dispensing a reagent into the cuvettes, and forwarding used cuvettes to the receptacle after finishing the measurements. Such apparatus has an incubation module where sample cuvettes are stored, a reagent module containing a reagent of an amount needed for the assay, and a measuring module favorably accommodating optical measuring points. Furthermore, it includes arms for moving the sample cuvettes, dispensing reagents of the necessary amount into the cuvettes, and forwarding used cuvettes to the receptacle after completion of the measurements. The apparatus is constructed in such a way that the cuvette removal point of the incubation module, the reagent removal point of the reagent holder module and the measuring points of the measuring module are arranged along a circular arc with a common geometric center, and a common axis of rotation is created in the said common geometric center. The arms are constructed on a common axis of rotation for moving the sample cuvettes vertically and at right angles to the axis of rotation, and for dispensing the necessary amount of reagents into the cuvettes.

In a favorable realization of apparatus, in the measuring module the measuring locations needed for the assay are arranged along one single circular arc. In this case the arms fixed on the common axis of rotation in a movable way have the same length.

In a further favorable realization of apparatus, in the measuring module the measuring points needed for the assay are arranged along several concentric circular arcs.

In a possible realization of apparatus the arms fixed on a common axis of rotation in a movable way are constructed in such a manner that they support the edge of the cuvette and/or are suitable for accommodating the reagent dispenser tip attached to a suction-and-discharge head.

Favorably, in subject apparatus, the length of the arms fixed on a common axis of rotation in a movable way may be determined in a size group or size groups suiting the length of the radius of the circular arc(s) created by the measuring points. The arms fixed on a common axis of rotation in a movable way may be moved by electronically controlled electric motors or by electronically controlled hydraulic or pneumatic drives.

Exemplary possible solutions, as examples, are described in detail on the basis of the attached drawings, without restricting scope of protection, where:

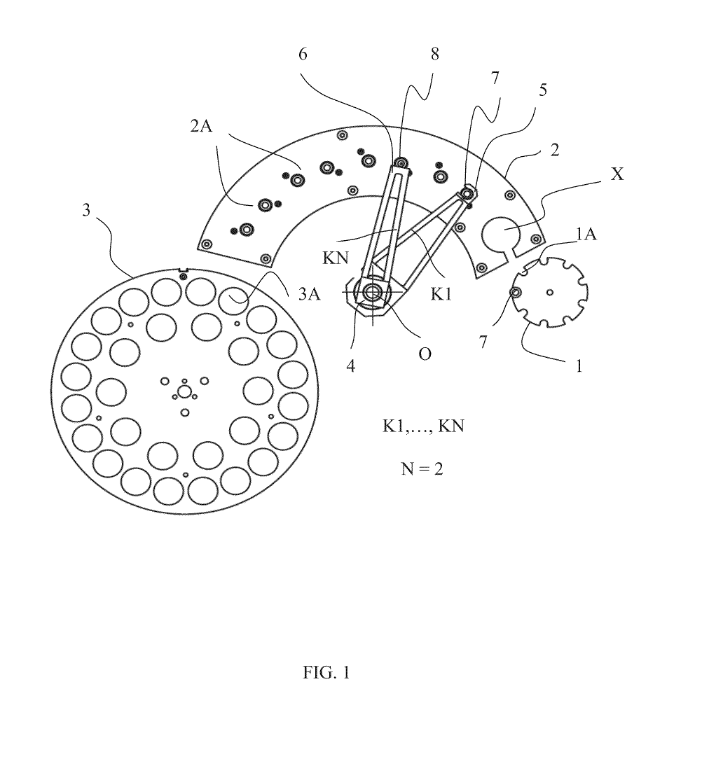

FIG. 1 depicts the schematic structure of a favorable realization of the apparatus,

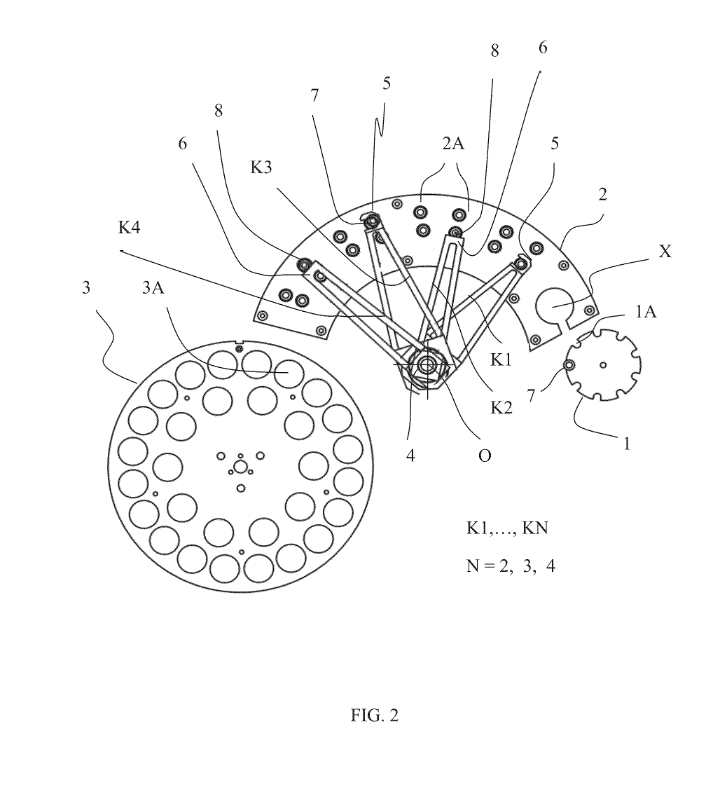

FIG. 2 depicts the plan of a further favorable four-armed form of execution of the apparatus, and,

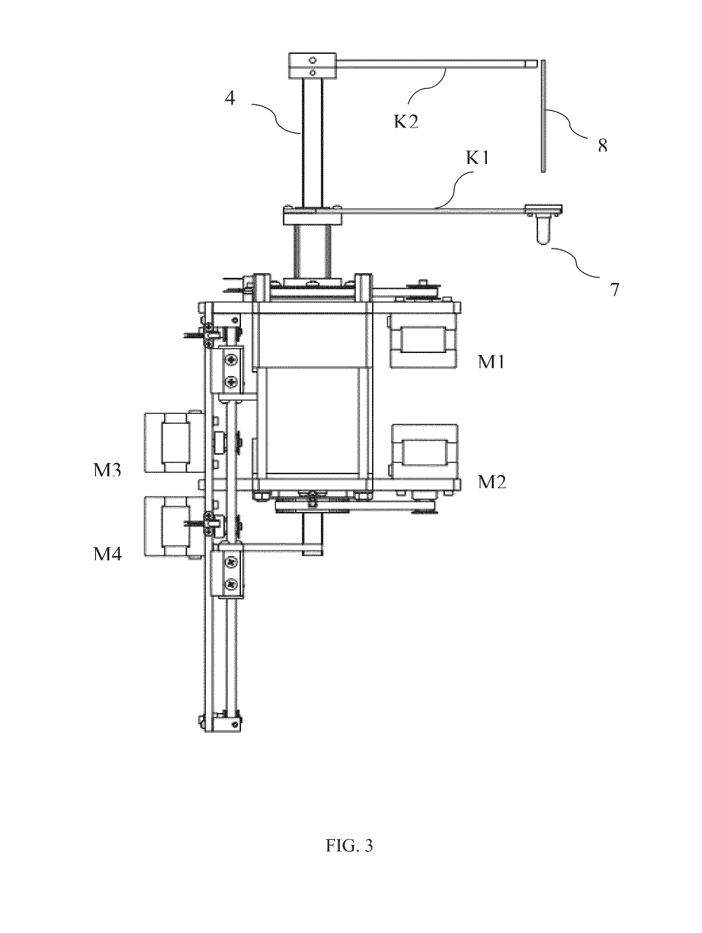

FIG. 3 depicts a side view of the apparatus, with the operating drives.

In the following description, numerous specific details are set forth in order to provide a thorough understanding. It will be apparent, however, to one skilled in the art that other versions according to the present disclosure may be practiced without some of these specific details. Furthermore, as used throughout this specification, the terms ‘a’, ‘an’, ‘at least’ do not denote a limitation of quantity, but rather denote the presence of at least one of the referenced item, and the term ‘a plurality’ denotes the presence of more than one referenced items.

The exemplary apparatus shown in FIG. 1 has an incubation module 1 containing sample cuvettes 7. It has a reagent module 3 containing a reagent of an amount needed for the assay and a measuring module 2 favorably accommodating optical measuring points 2A. Furthermore it contains arms K1, . . . , KN—where N is a natural whole number—for moving the sample cuvettes 7 and for dispensing the necessary amount of reagents into the cuvettes 7. The apparatus is constructed in such a manner that in the incubation module 1 the removal location 1A of the sample cuvettes 7, the reagent removal point 3A of the reagent holder module 3 and the measuring locations 2A of the measuring module 2 are arranged along a circular arc having a common geometric center O. In accordance with this the removal point 1A of the sample cuvettes 7 in the incubation module 1 and the reagent removal location 3A of the reagent holder module 3 are rotated to the circular arc(s) created by the measuring locations 2A of the measuring module 2. In the common geometric center O according to the construction of the apparatus, there is a common axis of rotation 4. Arms K1, . . . , KN are positioned on the common axis of rotation 4 for moving the sample cuvettes 7 vertically and at right angles to the axis of rotation 4, dispensing the necessary amount of reagents into the cuvettes 7 and forwarding the cuvettes 7 into the receptacle X after finishing the measurements.

In a favorable construction of apparatus depicted in FIG. 1, in the measuring module 2 the measuring points 2A needed for the assay are positioned along one single circular arc. In this case, the arms K1, K2 fixed on a common axis of rotation 4 have the same length. The arms K1, K2 fixed on a common axis of rotation 4 may be constructed in such a way that they support the edge 5 of the cuvette 7 and/or are suitable for accommodating the reagent dispenser tip 8 attached to a suction-and-discharge head 6.

In a further favorable realization of exemplary apparatus, as depicted in FIG. 2, in the measuring module 2 the measuring points 2A needed for the assay are positioned along several concentric circular arcs. Favorably, in the apparatus the respective lengths of the arms K1, K2, K3, K4 fixed on a common axis of rotation 4 in a movable way are determined in a size group or size groups suiting the length of the radius of the circular arc(s) created by the measuring points 2A. Therefore, in the case of the form of realization shown in FIG. 2, suiting the given length of radius, two arms K1, K2 have the same length, and the other two arms K3, K4 have the same length, it can be seen that arms K1, K2 are shorter than arms K3, K4, and each arm K1, K2, K3, K4 is positioned in a different plane. Among the arms K1, K2, K3, K4 fixed on a common axis of rotation 4 in a movable way arms K1, K3 are constructed in such a manner that they support the edge 5 of the cuvette 7, while arms K2, K4 are constructed in such a way that they are suitable for accommodating the reagent dispenser tip 8 attached to a suction-and-discharge head 6.

FIG. 3 shows a schematic side-view of a favorable realization of the apparatus according to the present disclosure. It can be seen that the arms K1, K2 shown are positioned in different planes, and arm K1 is constructed in such a way that it supports the edge 5 of the cuvette 7, while arm K2 is constructed in such a way that it is suitable for accommodating the reagent dispenser tip 8 attached to a suction-and-discharge head 6. The arms K1, K2 fixed on a common axis of rotation 4 in a movable way are moved by electronically controlled electric motors M1, M2, M3, M4, or by electronically controlled hydraulic or pneumatic drives. In the case of the favorable realization shown in FIG. 3 controlled electric motors M1, M2 are the drives of the rotating motion, while controlled electric motors M3, M4 are the drives of the vertical motion. Furthermore, electric motors M1, M3 move arm K2, while electric motors M2, M4 move arm K1.

The operation an apparatus according to the present disclosure for placing cuvettes 7 at the measuring locations 2A and dispensing a reagent into the cuvettes 7 is described below in detail.

The cuvette 7 containing the assay sample is moved from the removal point 1A of the incubation module 1 by appropriately moving arm K1 to one of the measuring locations 2A positioned along a circular arc in the measuring module 2. At the measuring point 2A the assay reagent(s) is (are) added and the reaction is measured, favorably in an optical measuring cell. The number of the measuring points 2A may vary depending on the speed of the automatic apparatus used. In practice this practically means that there are at least four measuring points 2A. When the measurements are finished, the used cuvettes 7 are forwarded to the receptacle X. In the case of the operation of the apparatus described in this example, the lower arm K1 or lower arms K1, K3 dispensing the cuvettes 7 also forward the used cuvettes to the receptacle X after the measurements are finished. A separate construction is also possible for this separate purpose.

The removal location 1A in the incubation module 1 and the reagent removal point 3A of the reagent holder module 3 are arranged along a circular arc or arcs formed by the measuring locations 2A of the measuring module 2. In accordance with this, the removal point 1A in the incubation module 1 and the reagent removal point 3A of the reagent holder module 3 are rotated lie on to the circular arc(s) created by the measuring points 2A of the measuring module 2. The common axis of rotation 4 of the arms K1, . . . , KN moved from a common center of rotation is positioned in the common geometric center O of the circular arc(s), and on the said common axis of rotation 4 for example arms K1, K2, K3, K4—two arms K1, K2 in FIG. 1, while all four arms K1, K2, K3, K4 in FIG. 2—enable the dispensing of the sample cuvette 7 and the dispensing of the assay reagent(s) simultaneously or at different times, as may be required.

With the help of the lower arm K1 or lower arms K1, K3 dispensing the cuvettes 7, from the removal point 1A of the incubation module 1 the sample cuvette 7 is moved above the measuring module 2, and then it is lowered into the desired measuring location 2A with a vertical motion. The same steps are repeated at further measuring points 2A, as required. At the same time, the upper arm K2 or upper arms K2, K4 used for dispensing the reagent, after drawing the necessary amount of reagent, rotate away from the reagent module 3 to a position above the desired measuring point 2A, and while performing a vertical downwards motion they lower the dispensing tip 8 into the cuvette 7 of the desired measuring point 2A. In the course of performing the vertical downwards motion, after reaching a selected height, the suction-and-discharge head 6 adds the reagent to the assay sample in the cuvette. The same steps are repeated at further measuring points 2A, as required.

As may be seen from FIG. 2, in the case of a favorable realization increasing the number of measuring points 2A, the increased number of measuring points 2A in the measuring module 2 are placed along several concentric circular arcs positioned behind each other, for example along two circular arcs in FIG. 2.

Favorably, the length of arms K1, . . . , KN positioned in the common geometric center O of the circular arrangement according to our procedure and moved from a common center of rotation and with a common axis of rotation 4 may be determined on the basis of the radii of the circular arc(s) formed by the measuring points measured from the common geometric center O. An example of this is shown in FIG. 2, where the measuring locations 2A are placed on two concentric circular arcs. In the case of this form of realization the arms K1, K2, K3, K4 moved from a common axis of rotation according to our procedure are favorably constructed in two size groups suiting the radius of the two circular arcs, in a shorter size—arms K1, K2—and a longer size—arms K3, K4.

In the case of a presented favorable solution, the arms K1, . . . , KN having a common center of rotation and a common axis of rotation 4 are moved horizontally and vertically, in such a way that the arms K1, . . . , KN are moved only in one direction at a time.

In the case of another favorable realization, in practice, the placement of the sample cuvettes 7 at the measuring locations 2A and the dispensing of the reagent into the cuvettes 7 is performed with separately moved arms K1, K2, arms K1, K3 and arms K2, K4, while with arms K1, K2, K3, K4 horizontal and vertical movement is performed continuously, in parallel.

In the case of a very favorable realization of our apparatus according to the present disclosure, the arms K1, K2 fixed on a common axis of rotation 4 in a movable way are moved by electronically controlled electric motors M1, . . . , M4 (FIG. 3), the joint operation of which is described above.

By realizing this solution there are achieved, in modular, compact and fast, technically simple and economical automatic apparatuses the movement of sample cuvettes 7 from the incubation module 1 to the measuring points 2A of the measuring module 2; also movement from the removal points 3A of the reagent module containing 3 the assay reagent to the measuring points 2A of the measuring module 2. After finishing the measurement, movement from the measuring locations 2A to the receptacle X is realized in a fast and simple manner.

Finally, it should be noted that the term “comprising” does not exclude other elements or features, and that use of the terms “a” or “an” does not necessarily exclude a plurality, in the sense that singular reference of an element does not exclude the plural reference of such elements. The verb ‘comprise’ and its conjugations do not exclude the presence of elements or steps other than those listed in any claim or the specification as a whole. The mere fact that certain measures are recited in mutually different dependent claims does not indicate that a combination of these measures cannot be used to advantage. Furthermore, elements described in association with different versions may be combined. Finally, it should be noted that the above-mentioned examples, and versions illustrate rather than limit the invention, and that those skilled in the art will be capable of designing many alternative implementations without departing from the scope of the invention as defined by the appended claims. As equivalent elements may be substituted for elements employed in claimed invention to obtain substantially the same results in substantially the same way, the scope of the present invention is defined by the appended claims, including known equivalents and unforeseeable equivalents at the time of filing of this application. Thus, in closing, it should be noted that the invention is not limited to the abovementioned versions and exemplary working examples. Further developments, modifications and combinations are also within the scope of the appended patent claims, and are placed in the possession of the person skilled in the art from the present disclosure. Accordingly, the techniques and structures described and illustrated previously herein should be understood to be illustrative and exemplary, and not necessarily limiting upon the scope.

What is claimed is:

1-20. (canceled)

21. Apparatus for sample cuvette handling comprising:
an incubation module configured to hold sample cuvettes, said incubation module having at least one cuvette removal location;
a measuring module, said measuring module having a plurality of measuring locations for making measurements;
a reagent module, said reagent module having at least one reagent removal location;
said at least one cuvette removal location, said at least one reagent removal location, and said plurality of measuring locations all being arranged along a circular arc having a common geometric center;
a plurality of rotatable arms, said plurality of rotatable arms having a common axis of rotation, said common axis of rotation being coincident with the common geometric center of said circular arc; and,
a plurality of respective drive motors operatively connected to controllably position respective arms of said plurality of rotatable arms vertically parallel to said common axis of rotation and also along said circular arc, to move cuvettes and to selectively dispense reagents into cuvettes and to dispose of cuvettes.

22. Apparatus for sample cuvette handling as claimed in claim 21, further comprising:
at least two of said plurality of rotatable arms have the same length.

23. Apparatus for sample cuvette handling as claimed in claim 21, further comprising:
at least one of said plurality of rotatable arms has a cuvette-edge support.

24. Apparatus for sample cuvette handling as claimed in claim 21, further comprising:
at least one of said plurality of rotatable arms has a reagent dispenser tip.

25. Apparatus for sample cuvette handling as claimed in claim 24, further comprising:
said reagent dispenser tip being operatively connected to a suction-and-discharge head.

26. Apparatus for sample cuvette handling as claimed in claim 21, further comprising:
said plurality of drive motors includes at least one electric motor.

27. Apparatus for sample cuvette handling as claimed in claim 21, further comprising:
said plurality of drive motors includes at least one fluid power motor.

28. Apparatus for sample cuvette handling comprising:
an incubation module configured to hold sample cuvettes, said incubation module having at least one cuvette removal location;
a measuring module, said measuring module having a plurality of measuring locations for making measurements;
a reagent module, said reagent module having at least one reagent removal location;
said at least one cuvette removal location, said at least one reagent removal location, and said plurality of measuring locations all being arranged along a plurality of concentric circular arcs having a common geometric center;
a plurality of rotatable arms, said plurality of rotatable arms having a common axis of rotation, said common axis of rotation being coincident with the common geometric center of said circular arcs; and,
a plurality of respective drive motors operatively connected to controllably position respective arms of said plurality of rotatable arms vertically parallel to said common axis of rotation and also along said circular arcs, to move cuvettes and to selectively dispense reagents into cuvettes and to dispose of cuvettes.

29. Apparatus for sample cuvette handling as claimed in claim 28, further comprising:
at least two of said plurality of rotatable arms have the same length.

30. Apparatus for sample cuvette handling as claimed in claim 28, further comprising:
at least two of said plurality of rotatable arms each have a respective cuvette-edge support.

31. Apparatus for sample cuvette handling as claimed in claim 28, further comprising:
at least two of said plurality of rotatable arms each have a respective reagent dispenser tip.

32. Apparatus for sample cuvette handling as claimed in claim 28, further comprising:
a plurality of size groups into which said plurality of rotatable arms are arranged, said plurality of size groups corresponding in number to the number of concentric circular arcs of said plurality of concentric circular arcs, with each one of said plurality of size groups corresponding to a respective one of said plurality of concentric circular arcs.

33. The apparatus for sample cuvette handling as claimed in claim 32 wherein:
the respective lengths of a rotatable arm within its respective one of said plurality of size groups is determined by the respective radius of the respective corresponding concentric circular arc.

34. A process for sample cuvette handling comprising the steps of:
holding cuvettes at an incubation module;
providing a cuvette removal location at the incubation module;
holding reagent at a reagent module;
providing a reagent removal location at the reagent module;
providing a plurality of measuring locations;
arranging all of the cuvette removal location, the reagent removal location, and the plurality of measuring locations, all, along a circular arc to have a common geometric center;
transferring cuvettes from the cuvette removal location to the measuring locations with an arm pivoted on the common geometric center;
transferring reagent from the reagent removal location to the measuring locations with an arm pivoted on the common geometric center;
dispensing reagent into cuvettes situated in the measuring locations; and,
transferring, with an arm pivoted on the common geometric center, used cuvettes to a receptacle.

35. A process for sample cuvette handling as claimed in claim 34, further comprising the step of:
separately moving plural arms to effect said steps of transferring cuvettes from the cuvette removal location to the measuring locations, of dispensing reagent into cuvettes, and of transferring used cuvettes to a receptacle.

36. A process for sample cuvette handling as claimed in claim 34, further comprising the step of:
jointly moving plural arms to effect said steps of transferring cuvettes from the cuvette removal location to the measuring locations, of dispensing reagent into cuvettes, and of transferring used cuvettes to a receptacle.

37. The process for sample cuvette handling as claimed in claim 34, wherein:
said steps of transferring cuvettes from the cuvette removal location to the measuring locations, of dispensing reagent into cuvettes, and of transferring used cuvettes to a receptacle, are simultaneously performed.

38. A process for sample cuvette handling as claimed in claim 34, further comprising the step of:
moving a plurality of arms horizontally along the circular arc and vertically parallel to an axis through the common geometric center.

39. A process for sample cuvette handling as claimed in claim 34, further comprising the steps of:
providing a second cuvette removal location at the incubation module;
providing a second reagent removal location at the reagent module;
providing an additional plurality of measuring locations; and,
arranging all of the second cuvette removal location, the second reagent removal location, and the additional plurality of measuring locations, all, along a second circular arc that has the common geometric center.

40. A process for sample cuvette handling as claimed in claim 39, further comprising the step of:
providing two size groups for a plurality of rotatable arms, the size groups corresponding in number to the two concentric circular arcs.
